(19) United States
(12) Patent Application Publication
(10) Pub. No.: US 2008/0069513 A1
(43) Pub. Date: Mar. 20, 2008

(54) FIBER OPTIC CABLE ENTRY DEVICE

(76) Inventor: Raymond J. Desanti, West Boylston, MA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/856,576

(22) Filed: Sep. 17, 2007

Related U.S. Application Data
(60) Provisional application No. 60/825,821, filed on Sep. 15, 2006.

(51) Int. Cl. G02B 6/00

(52) U.S. Cl. 385/137

(57) ABSTRACT

A device for routing a fiber optic cable, the device including a housing having an inlet port sized to receive a section of the fiber optic cable and an outlet port adapted to redirect the section of the fiber optic cable within the housing; and a guide disposed within the housing, the guide sized and configured to direct the section of the fiber optic cable between the input and outlet ports and to prevent the section of the fiber optic cable from bending beyond a predetermined radius of curvature. A kit for installing fiber optic cable at a premise including the device. A method for installing a fiber optic cable into a premise using the device.

### CROSS-REFERENCE TO RELATED APPLICATION

This application claims the benefit of U.S. Provisional Application No. 60/825,821, filed Sep. 15, 2006, which application is expressly incorporated herein by reference in its entirety.

### BACKGROUND OF THE INVENTION

Fiber optic cables are widely used in telecommunications systems to carry optical signals. For fiber-to-the-premise or fiber-to-the-home installations, fiber optic cables must enter the premise for customer interface. Unlike electrical wires and cable, fiber optic cable cannot be kinked or excessively coiled without risking damage to the fiber optic cable and loss of optical signal. Fiber optic cables have a minimum bend radius: the fiber becomes damaged when bent beyond that radius.

A need exists for a device for permitting entry of fiber optic cable to a premise. The present invention seeks to fulfill this need and provides further related advantages.

### SUMMARY OF THE INVENTION

The present invention provides a fiber optic cable entry device that permits the routing of fiber optic cable without damaging the cable. The device routes the fiber optic cable into the premise and prevents the cable from bending beyond the radius that exceeds the cable's minimum bend radius, thereby allowing entry of the cable without damage to the cable.

In one aspect, the invention provides device for routing a fiber optic cable. The device includes:

(a) a housing having an inlet port sized to receive a section of the fiber optic cable and an outlet port adapted to redirect the section of the fiber optic cable within the housing; and

(b) a guide disposed within the housing, the guide sized and configured to direct the section of the fiber optic cable between the input and outlet ports and to prevent the section of the fiber optic cable from bending beyond a predetermined radius of curvature.

In another aspect of the invention, a kit for installing fiber optic cable at a premise is provided. The kit includes a device for routing a fiber optic cable that includes:

(a) a housing having an inlet port sized to receive a section of the fiber optic cable and an outlet port adapted to redirect the section of the fiber optic cable within the housing; and

(b) a guide disposed within the housing, the guide sized and configured to direct the section of the fiber optic cable between the input and outlet ports and to prevent the section of the fiber optic cable from bending beyond a predetermined radius of curvature.

In a further aspect, a method for installing a fiber optic cable into a premise is provided. In one embodiment, the method includes:

(a) inserting the terminal end of a fiber optic cable into an inlet port of a device, the device comprising:
(i) a housing having the inlet port and an outlet port adapted to redirect the section of the fiber optic cable within the housing; and
(ii) a guide disposed within the housing, the guide sized and configured to direct the section of the fiber optic cable between the input and outlet ports and to prevent the section of the fiber optic cable from bending beyond a predetermined radius of curvature;

(b) passing the terminal end of the fiber optic cable from the outlet port of the housing.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a representative fiber optic cable entry device of the present invention;

FIG. 2 is an exploded view of the representative device of the invention illustrated in FIG. 1;

FIG. 3 illustrates a cross-sectional view of an installed representative device of the invention illustrating the perpendicular relationship between inlet port and outlet port and the bend radius limiter for preventing the fiber optic cable from exceeding its minimum bend radius;

FIG. 4 is a perspective view of a representative fiber optic cable entry device of the present invention; and

FIG. 5 illustrates the components of a kit useful for installing a representative device of the invention: elbow housing, bend radius limiter, fiber conduit, mounting bracket, and trim ring.

### DETAILED DESCRIPTION OF THE INVENTION

The present invention provides a fiber optic cable entry device useful for directing one or more fiber optic drop cables present outside of a premise into the inside of the premise (e.g., home or office). Fiber optic cable deployment for these fiber-to-the-premise (FTTP) installations employs one or more fibers for connection of an optical network device or terminal (ONT) located within the premise to the fiber distribution cable plant located external to the premise. In one embodiment, the device of the invention allows for entry of the fiber optic cable into the premise in a perpendicular (90 degree) manner.

In one aspect, the invention provides a device for routing a fiber optic cable. The device includes:

(a) a housing having an inlet port sized to receive a section of the fiber optic cable and an outlet port adapted to redirect the section of the fiber optic cable within the housing; and

(b) a guide disposed within the housing, the guide sized and configured to direct the section of the fiber optic cable between the input and outlet ports and to prevent the section of the fiber optic cable from bending beyond a predetermined radius of curvature.

In one embodiment, the outlet port redirects the section of the fiber optic cable to in a direction that is substantially perpendicular (90 degree) to the direction of the section of fiber entering the inlet port.

In one embodiment, the predetermined radius of curvature is equal to or greater than a minimum bend radius of the fiber optic cable. In one embodiment, the minimum bend radius of the optical fiber is about 1.5 inches (i.e., a minimum bend diameter of about 3 inches).

The device of the invention can be adapted to prevent any fiber optic cable from exceeding its minimum bend radius or diameter. This feature of the invention is achieved by the device's guide (bend limiter) component. The device's guide serves to limit the bend of the fiber passing through and/or exiting from the housing by preventing the fiber cable from bending beyond its minimum bend radius. In one embodiment, the guide includes an arcuate section having a radius equal to or greater than the minimum bend radius of the fiber optic cable.

The guide is positioned intermediate the input and output ports of the housing. The guide (or bend radius limiter) (e.g., waterfall or bridge) allows for the section of fiber optic cable to pass through the housing (entering the inlet port and exiting the outlet port) or extend from the housing (jumper cable or patch cord in the embodiment that includes an adapter) while preventing the fiber optic cable from bending beyond its minimum bend radius. In one embodiment, the bend radius limiter includes an arcuate section having a radius sufficient to safely guide the fiber optic cable.

The fiber distribution cable plant (i.e., the input fiber optic cable) can approach the premise either underground or through aerial overhead cabling.

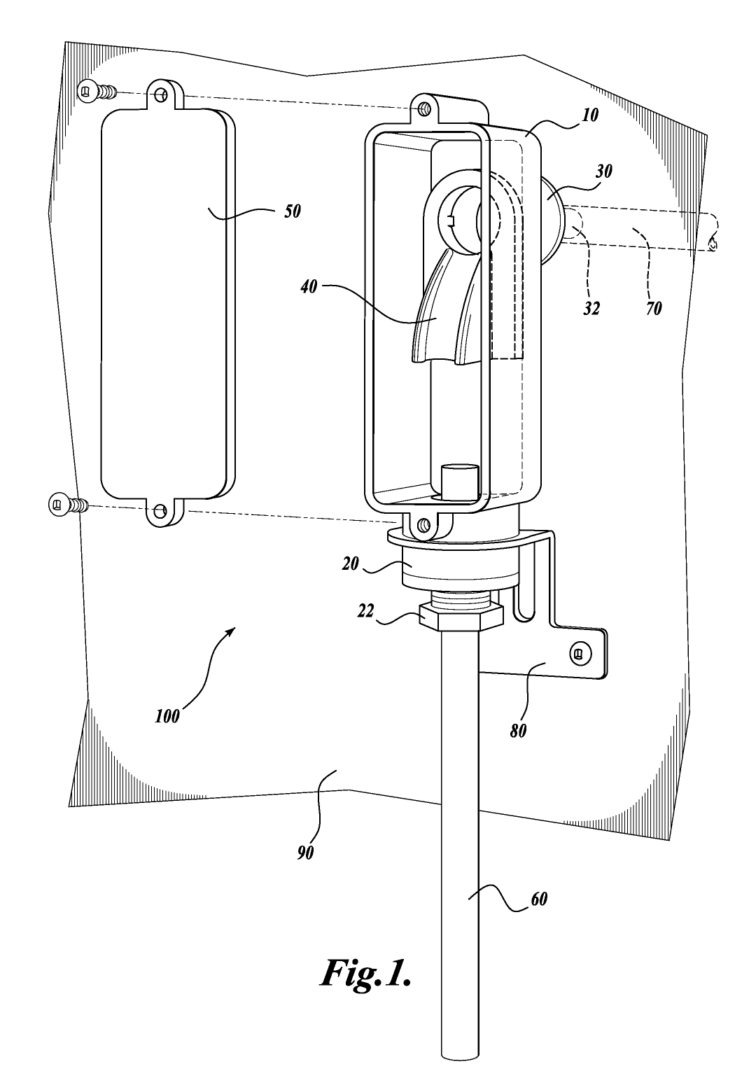

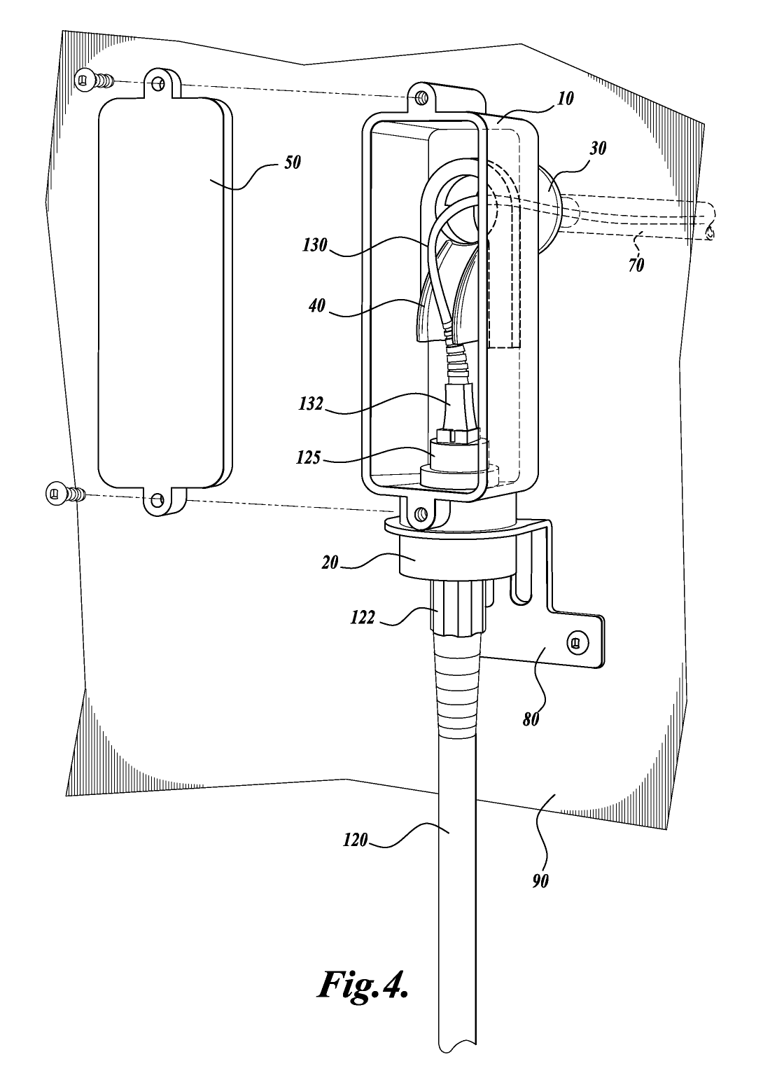

FIGS. 1 and 4 illustrate representative embodiments of the device of the invention.

In one embodiment, the cable enters the housing of the device of the invention and can be fed through the device directly into the premise. In this embodiment, the housing includes a means for protectively coupling a conduit carrying the input cable such that the cable is protected from the environment at entry to the housing. For example, the conduit carrying the cable to the device of the invention can be coupled to the housing by, for example, a threaded compression fitting. This embodiment is illustrated in FIGS. 1-3. In this embodiment, the inlet port further includes a fitting for securing a fiber optic conduit to the housing. This embodiment can be used to direct one or more (e.g., two) fiber optic cables into the premise. In these embodiments, the conduit carries more than one fiber optic cable to the premise.

Alternatively, in another embodiment, the housing can further include an adapter for connecting an input fiber optic cable (from the fiber distribution cable plant) to an output fiber optic cable (e.g., jumper cable or patch cord). In this embodiment, the adapter (e.g., hardened optical adapter) is positioned within the housing adjacent the inlet port and receives the connectors from the input and output fiber optic cables. The output fiber optic cable (e.g., jumper cable or patch cord) and its connector are also connected to the adapter making an optical connection. Suitable adapters are known to those of skill in the art, for example, SC/APC, SC/OPC, OPTI TAP SCOUT. In this embodiment, the connection of the input and output fiber optic cables (i.e., demarcation) provides a convenient test point for servicing the fiber optic cable system. This embodiment is illustrated in FIG. 4.

In one embodiment, the device of the invention includes a cable conduit that directs the output fiber optic cable from the housing through the premise wall to the interior of the premise. The conduit is connected to the outlet port of the housing. The length of the conduit can be varied and is sufficient to facilitate connection between the housing and the interior of the premise. Typically, the conduit has a length from about 10 to about 16 inches. The conduit enters the premise by a hole drilled in the premise wall and placing the conduit through the drilled hole. In this embodiment, the outlet port is adapted to receive the conduit that directs the fiber optic cable from the housing.

The device of the invention is further illustrated by reference to the drawings.

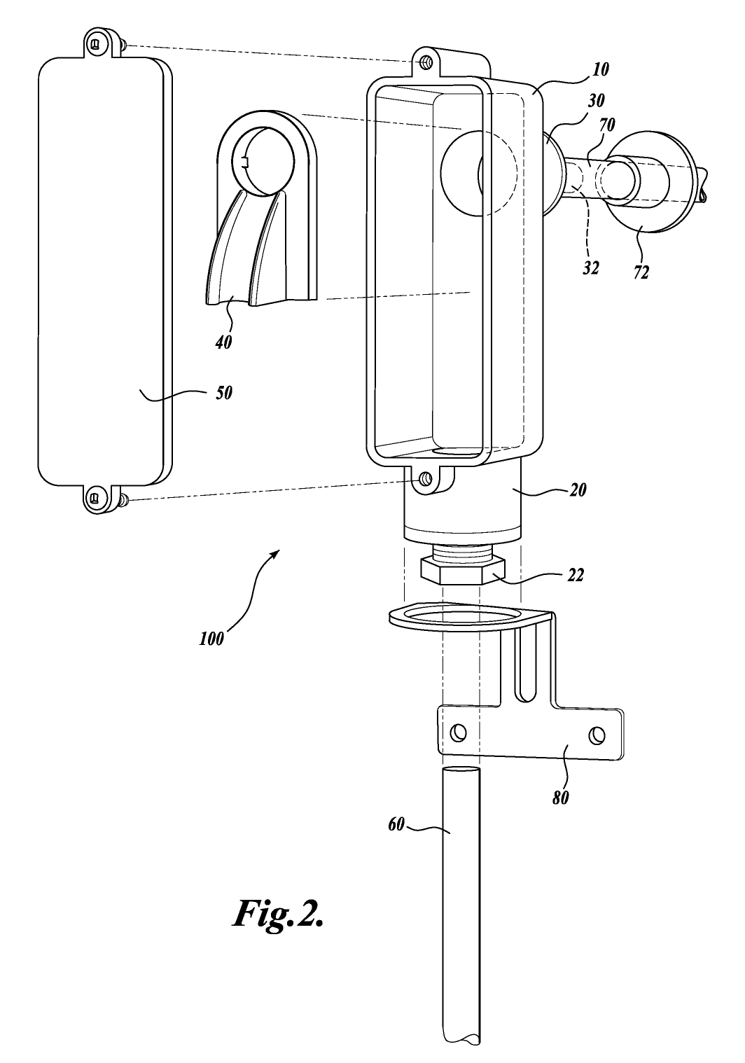

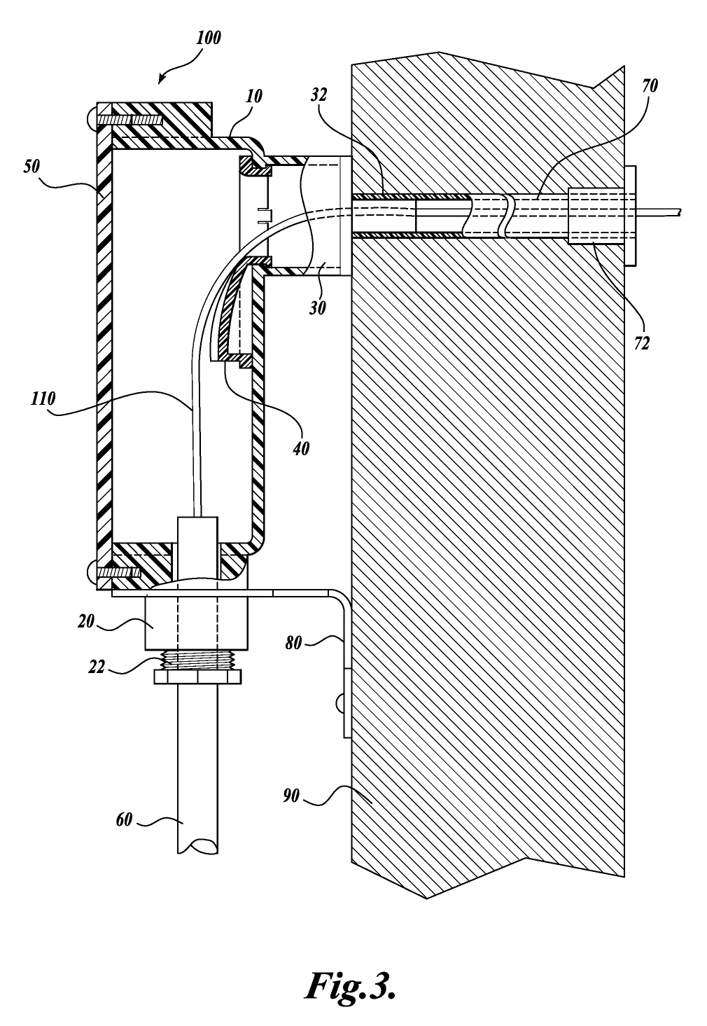

A first embodiment of the invention is illustrated in FIGS. 1-3. FIG. 1 is a perspective view of a representative fiber optic cable entry device of the present invention with cover plate removed; FIG. 2 is an exploded view of the representative device of the invention illustrated in FIG. 1; and FIG. 3 illustrates a cross-sectional view of an installed representative device of the invention illustrating the perpendicular relationship between inlet port and outlet port and the bend radius limiter for preventing the fiber optic cable from exceeding its minimum bend radius.

Referring to FIGS. 1-3, representative device 100 includes elbow housing 10 having inlet port 20 and outlet port 30. Intermediate the inlet and outlet ports is guide 40 illustrated as having an arcuate section to guide fiber optic cable 110 (see FIG. 3) through the housing and preventing the fiber from bending beyond its minimum bend radius. Housing 10 includes cover plate 50, reversibly affixable to the housing. The housing includes means 22 (threaded compression fitting) for coupling conduit 60 carrying the input fiber optic cable such that the cable is protected from the environment at entry to the housing. The outlet port of the housing is adapted by means 32 to receive conduit 70 for directing the fiber optic cable from the housing. Conduit 70 is adapted to receive trim ring 72 (see FIGS. 2 and 3).

A second embodiment of the invention is illustrated in FIG. 4. FIG. 4 is a perspective view of a representative device of the present invention with cover plate 50 removed, exposing the interior of housing 10 showing connection of output fiber optic cable 130 to input fiber optic cable 120 through adapter 125. Referring to FIG. 4, input fiber optic cable 120 terminating with connector 122 is received by inlet port 20 and adapter 125. Similarly, output fiber optic cable 130 terminating with connector 132 is received by adapter 125, which facilitates an optical connection between cables 120 and 130. Output fiber optic cable 130 exits housing 10 through outlet port 30.

Bracket 80 for mounting housing 10 on the exterior of a premise 90 is shown in FIGS. 1-4.

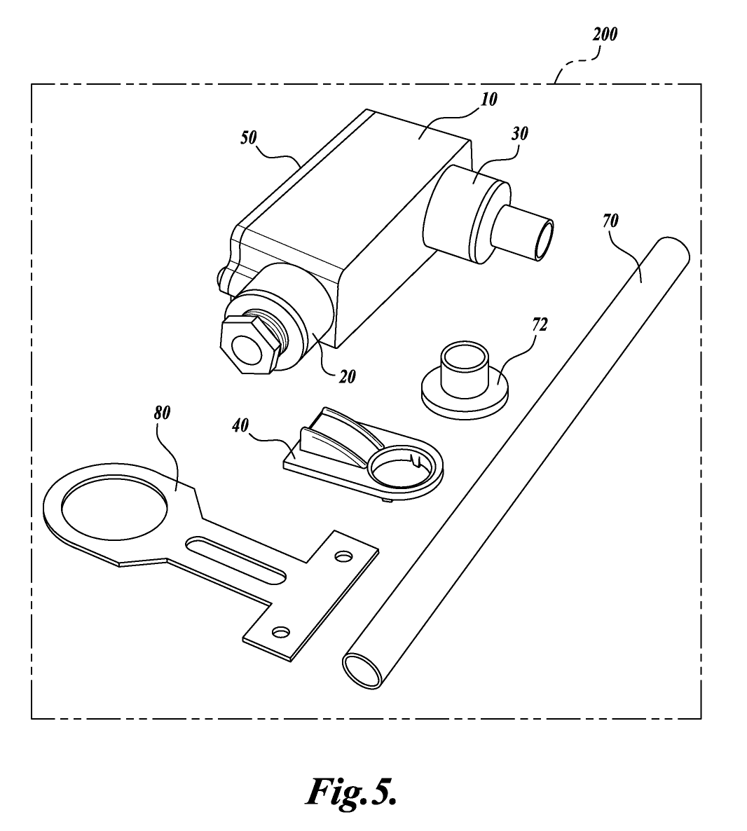

In another aspect, the invention provides a kit for installing fiber optic cable at a premise. The kit includes the device for routing a fiber optic cable described above. The components of a representative kit of the invention are illustrated in FIG. 5. In addition to housing 10 having features 20 and 30, cover plate 50, and guide 40, kit 200 can optionally include one or more of the following components: conduit 70 for directing the section of fiber optic cable from the device to the interior of the premise, trim ring 72, and bracket 80 for mounting the device on the exterior of the premise. The kit can also include instructions for installing the device at the premise. The components of the kit can be packaged together.

In another aspect of the invention, a method for installing a fiber optic cable into a premise is provided. The method utilizes the device for routing a fiber optic cable described above. The method can utilize the embodiments of the devices of the invention illustrated in FIG. 1 or FIG. 4.

In one embodiment, the method includes:

(a) inserting the terminal end of a fiber optic cable into an inlet port of a device, the device comprising:

(i) a housing having the inlet port and an outlet port adapted to redirect the section of the fiber optic cable within the housing; and

(ii) a guide disposed within the housing, the guide sized and configured to direct the section of the fiber optic cable between the input and outlet ports and to prevent the section of the fiber optic cable from bending beyond a predetermined radius of curvature; and

(b) passing the terminal end of the fiber optic cable from the outlet port of the housing.

In one embodiment, the device is mounted on the exterior of the premise.

In one embodiment, the device outlet port is connected to a conduit leading to the interior of the premise.

While illustrative embodiments have been illustrated and described, it will be appreciated that various changes can be made therein without departing from the spirit and scope of the invention.

The embodiments of the invention in which an exclusive property or privilege is claimed are defined as follows:

1. A device for routing a fiber optic cable, the device comprising:
(a) a housing having an inlet port sized to receive a section of the fiber optic cable and an outlet port adapted to redirect the section of the fiber optic cable within the housing; and
(b) a guide disposed within the housing, the guide sized and configured to direct the section of the fiber optic cable between the input and outlet ports and to prevent the section of the fiber optic cable from bending beyond a predetermined radius of curvature.

2. The device of claim 1, wherein the outlet port redirects the section of the fiber optic cable to in a direction that is substantially perpendicular to the direction of the section of fiber entering the inlet port.

3. The device of claim 1, wherein the guide includes an arcuate section.

4. The device of claim 3, wherein the arcuate section has a radius equal to or greater than a minimum bend radius of the fiber optic cable.

5. The device of claim 1, wherein the predetermined radius of curvature is equal to or greater than a minimum bend radius of the fiber optic cable.

6. The device of claim 5, wherein the minimum bend radius of the optical fiber is about 1.5 inches.

7. The device of claim 1, wherein the inlet port further comprises a fitting for securing a fiber optic conduit to the housing.

8. The device of claim 1, further comprising an adapter for receiving the fiber optic cable from the inlet port and for receiving a second fiber optic cable from the outlet port, wherein the adapter provides an optical connection between the cables.

9. The device of claim 1, wherein the outlet port is adapted to receive a conduit for directing the section of fiber optic cable from the housing.

10. The device of claim 1, wherein the housing further comprises a reversibly affixable cover plate to allow entry to an interior of the housing.

11. A kit for installing fiber optic cable at a premise, comprising the device of claim 1.

12. The kit of claim 11, further comprising a conduit for directing the section of fiber optic cable from the device to the interior of the premise.

13. The kit of claim 11, further comprising a trim ring.

14. The kit of claim 11, further comprising a conduit cap.

15. The kit of claim 11, further comprising a device for mounting the device on the exterior of the premise.

16. The kit of claim 11, further comprising instructions for installing the device at the premise.

17. A method for installing a fiber optic cable into a premise, comprising:
(a) inserting the terminal end of a fiber optic cable into an inlet port of a device, the device comprising:
(i) a housing having the inlet port and an outlet port adapted to redirect the section of the fiber optic cable within the housing; and
(ii) a guide disposed within the housing, the guide sized and configured to direct the section of the fiber optic cable between the input and outlet ports and to prevent the section of the fiber optic cable from bending beyond a predetermined radius of curvature;
(b) passing the terminal end of the fiber optic cable from the outlet port of the housing.

18. The method of claim 17, wherein the device is mounted on the exterior of the premise.

19. The method of claim 17, wherein the device outlet port is connected to a conduit leading to the interior of the premise.
